(19) United States
(12) Patent Application Publication
(10) Pub. No.: US 2014/0126253 A1
(43) Pub. Date: May 8, 2014

(54) POWER SUPPLY SYSTEM WITH DYNAMIC FILTERING

(71) Applicants: Daniel Humphrey, Cypress, TX (US); Mohamed Amin Bemat, Cypress, TX (US); Mark Trace, Spring, TX (US)

(72) Inventors: Daniel Humphrey, Cypress, TX (US); Mohamed Amin Bemat, Cypress, TX (US); Mark Trace, Spring, TX (US)

(73) Assignee: Hewlwtt-Packard Development Company, L.P., Fort Collins, CO (US)

(21) Appl. No.: 14/127,950

(22) PCT Filed: Jul. 20, 2011
(86) PCT No.: PCT/US2011/044641

§ 371 Date: Dec. 19, 2013

(51) Int. Cl. H02M 1/44

(52) U.S. Cl. CPC H02M 1/44
USPC 363/44

(57) ABSTRACT

A power supply system (10) and method (150) are disclosed. The system (10) includes a power converter (16) to provide an output voltage to a load (12) based on an input voltage that is generated from an AC supply voltage. The system (10) also includes a power monitor (16) to monitor the load (12). The system (10) further includes a filter stage (14) to dynamically filter high frequency currents generated by the power converter (16) from the AC supply voltage to substantially maximize a power factor associated with the power supply system (10).

### BACKGROUND

Power converters can be implemented in a variety of electronic devices to convert an input voltage to an output voltage. As an example, some power converters can be configured to convert an alternating current (AC) voltage, such as provided from utility power, to another voltage, such as a direct current (DC) voltage. Electromagnetic Interference (EMI) filters can typically be required to meet international guidelines for injection of high frequencies out through an input line cord. These filters are normally passive elements, which can be a constant load for an input power source.

### BRIEF DESCRIPTION OF THE DRAWINGS

FIG. 1 illustrates an example of a power supply system.

FIG. 2 illustrates an example of an EMI filter stage.

FIG. 3 illustrates another example of a power supply system.

FIG. 4 illustrates an example of a method for dynamically providing EMI filtering in a power supply system.

### DETAILED DESCRIPTION

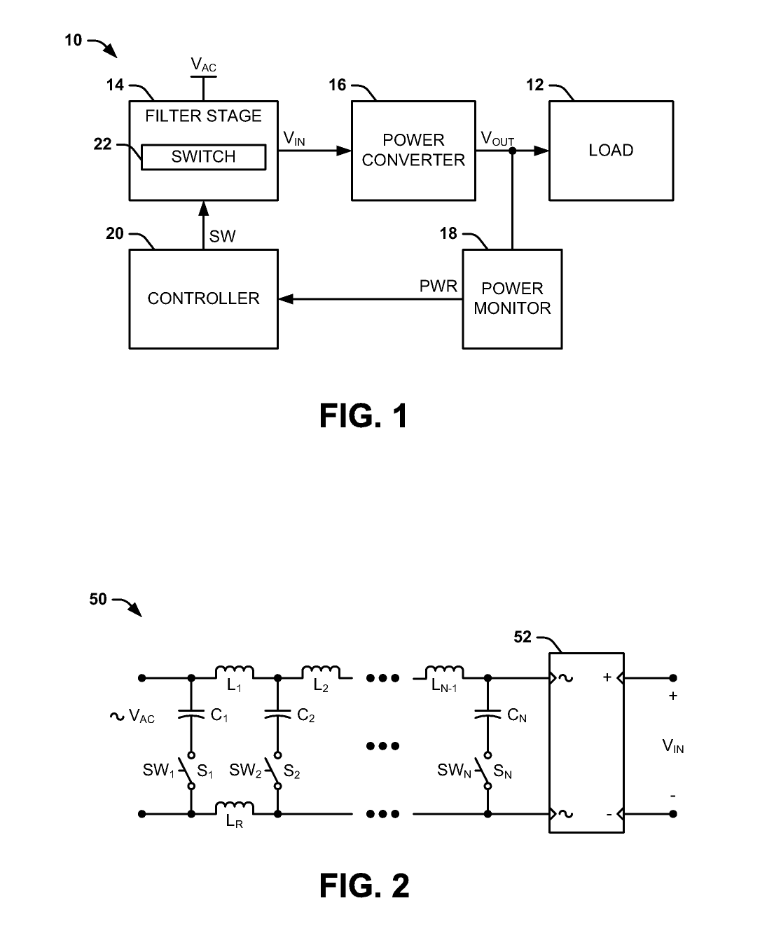

FIG. 1 illustrates an example of a power supply system 10. For example, the power supply system 10 can be implemented in any of a variety of electronic devices, such as a computer or server system. The power supply system 10 can be configured to provide power to a load 12 from an alternating current (AC) power source, demonstrated in the example of FIG. 1 as an AC supply voltage V_{AC}. The power supply system 10 also includes a filter stage 14 that filters high-frequency currents generated at an input voltage V_{IN} from the supply voltage V_{AC}. As an example, the filter stage 14 can be implemented as an EMI filter stage that includes a set of one or more passive filter components, such as capacitors, that can be configured to meet a specification, such as an international noise specification, during a full-load condition. As used herein, a full-load condition can correspond to a heavy load condition exceeding a predetermined threshold, such as according a predetermined specification. The filter stage 14 can also include a rectifier, such that the input voltage V_{IN} can be a direct current (DC) voltage. The power supply system 10 further includes a power converter 16 that is configured to generate an output voltage V_{OUT} based on the input voltage V_{IN}. The output voltage V_{OUT} is thus provided to power the load 12.

As an example, the power converter 16 can be configured as any of a variety of power converter types, such as a buck converter, a boost converter, a buck/boost converter, or a resonant power converter. The power converter 16 thus can be implemented as a switching converter to generate the output voltage V_{OUT} in response to activation of one or more power switches. For example, the switches can be configured as metal-oxide semiconductor field effect transistors (MOSFETs) that provide current flow through an inductor to generate the output voltage V_{OUT}. The power converter 16 can employ other types of switch devices. As another example, the power converter 16 can be configured as a power factor correcting (PFC) power converter that is configured to regulate the output voltage V_{OUT} as well as an input current associated with the input voltage V_{N}. The load 12 can be implemented as a separate DC/DC converter that is configured to further regulate a voltage provided to any of a variety of electronic components based on the output voltage V_{OUT}. The load can be implemented as other types of circuitry.

Because the supply voltage V_{AC} is provided from an AC power source, the passive components (e.g., capacitors) can draw substantially constant current. The constant current can become a significant contributor to a total root-mean square (RMS) current entering the filter stage 14. As used herein, the power factor can be calculated as a ratio of total power delivered to a product of RMS voltage and RMS current. Therefore, as the RMS current decreases for a same magnitude of power, the power factor increases. However, during light-load conditions, the power factor of the power supply system 10 can be greatly diminished based on the contribution of the constant current to the total RMS current.

As a result, the filter stage 14 can be configured to dynamically adjust its filtering of high frequency currents in the input voltage V_{IN} from the supply voltage V_{AC} based on the power required by the load 12. In the example of FIG. 1, the power supply system 10 includes a power monitor 18 configured to monitor a power of the power supply system 10, such as to quantify the load 12. While the example of FIG. 1 demonstrates that the power monitor 18 is coupled to the output voltage V_{OUT}, it is to be understood that the power monitor 18 can be coupled to one or more other parts of the power supply system 10 to obtain the power of the power supply system 10 for use in quantifying the load characteristics. The power monitor 18 provides a power indication signal PWR to a controller 20. As an example, the power indication signal can be a voltage signal having a magnitude that is proportional to the power, which quantifies the load characteristics.

The controller 20 can be configured to quantify the load 12 (e.g., a level of power consumption) based on the power indication signal PWR. For example, the controller 20 can determine if the power supply system 10 is operating in a full-load condition, a light-load condition or somewhere in between. As an example, the controller 20 can compare a value indicative of the load characteristics (e.g., derived from the power indication signal PWR) with a maximum rated load or with one or more thresholds to determine if the power supply system 10 is operating in the full-load condition or the light-load condition. Therefore, the controller 20 can be configured to dynamically control the filtering of high frequency currents to the supply voltage V_{AC} by the filter stage 14 via one or more switching signals SW based on the power indication signal PWR, corresponding to a magnitude of the load. That is, the controller can dynamically control the filter stage 14 depending on whether the power supply system 10 is operating in the full- or heavy-load condition or the light-load condition.

In the example of FIG. 1, the filter stage 14 includes one or more switches 22 that can be arranged in series with the passive filter components (e.g., capacitors) of the filter stage 14. The controller 20 thus can activate the switch(es) 22 to provide switching signals SW to couple the passive filter components to the filter stage 14 in full- or heavy-load operating conditions. Alternatively, the controller 20 can provide switching signals SW to selectively deactivate the switch(es) 22 to decouple the passive filter components from the filter stage 14 in light-load operating conditions. As an example, the controller 20 can be programmed (e.g., including machine readable instructions stored in memory or employ embedded logic) to identify which of the switch(es) 22 can be deactivated to decouple the passive filter components to maintain compliance with specification requirements regarding filtering of high frequency components to the supply voltage V_{AC} at the respective load magnitude that is indicated by the power indication signal PWR. In this way, deactivation of the identified switch(es) 22 can result in an increase in the power factor of the power supply system 10 during light load conditions. Accordingly, the power supply system 10 can be configured to provide sufficient power to the load 12 at an optimized power factor while still complying with specification requirements regarding EMI filtering of high frequency currents from the power converter 16 to the supply voltage V_{AC} during a light-load operating condition.

FIG. 2 illustrates an example of an EMI filter stage 50. The EMI filter stage 50 can correspond to the filter stage 14 in the example of FIG. 1. Therefore, reference can be made to the example of FIG. 1 in the example of FIG. 2 for additional context.

The EMI filter stage 50 includes a plurality N of capacitors and a corresponding plurality N of switches, demonstrated in the example of FIG. 2 as C₁ through C_{N} and S₁ through S_{N}, respectively. As an example, the switches S₁ through S_{N} can be configured as any of a variety of field effect transistors (FETs). Each of the capacitors C₁ through C_{N} is arranged in series with a respective one of the switches S₁ through S_{N}, with each of the series connections being separated by an inductor, demonstrated in the example of FIG. 2 as L₁ through L_{N-1}. The EMI filter stage 50 also includes an inductor L_{R} separating the branch of the capacitor C₁ and the switch S₁ and the branch of the capacitor C2 and the switch S2. Therefore, the EMI filter stage 50 comprises a number of passive circuit components that can provide EMI filtering of the supply voltage V_{AC} that is supplied to an input of the EMI filter stage 50. While the example of FIG. 2 demonstrates that the number of capacitors C₁ through C_{N} is equal to the number of respective switches S₁ through S_{N}, it is to be understood that the EMI filter stage 50 could include fewer switches. Furthermore, in the example of FIG. 2, the EMI filter stage 50 also includes a rectifier 52 that is configured to rectify the supply voltage V_{AC} to generate the input voltage V_{IN} as a corresponding DC voltage.

The controller 20 in the example of FIG. 1 can be configured to activate and deactivate the switches S₁ through S_{N} via respective switching signals SW₁ through SW_{N}, such as based on the magnitude of the load 12, as indicated by the power indication signal PWR. As a result, the controller 20 can selectively couple and decouple the respective capacitors C₁ through C_{N} to the EMI filter stage 50. As described herein, a given capacitor C_{X} is coupled to the EMI filter stage 50 when the respective switch S_{X} is activated (i.e., closed), such that the given capacitor C_{X} provides capacitance to the EMI filter stage 50 to contribute to the filtering of the supply voltage V_{AC}. Thus, similarly, the given capacitor C_{X} is decoupled from the EMI filter stage 50 when the respective switch S_{X} is deactivated (i.e., open), such that the given capacitor C_{X} does not provide capacitance to the EMI filter stage 50, and therefore does not contribute to the filtering for the supply voltage V_{AC}.

The EMI filter stage 50 can be designed to provide EMI filtering to specification (e.g., according to international guidelines) at full-load operating condition, such as based on the sizing of the capacitors C₁ through C_{N}. Therefore, during a full-load operating condition, the controller 20 can activate all of the switches S₁ through S_{N} via the respective switching signals SW₁ through SW_{N} during a full-load operating condition to provide sufficient filtering for the supply voltage V_{AC} according to specification. However, in response to determining that the power supply system 10 is operating in a light-load condition, the controller 20 can selectively deactivate one or more of the switches S₁ through S_{N} via the respective switching signals SW₁ through SW_{N} to dynamically adjust the filtering of the high frequency currents from the power converter 16 to the supply voltage V_{AC}.

As an example, the controller 20 can determine an amount of capacitance that is sufficient for maintaining filtering regulation for the supply voltage V_{AC} at a given magnitude of the load 12 that is less than full-load condition (i.e., in the light-load condition). Thus, the controller 20 can deactivate one or more of the switches S₁ through S_{N} via the respective switching signals SW₁ through SW_{N} to decouple the respective capacitors C₁ through C_{N} from the EMI filter stage 50. As an example, the capacitors C₁ through C_{N} can be sized substantially the same, such that each of the capacitors C₁ through C_{N} contribute approximately the same amount of capacitance to the EMI filter stage 50. As another example, the capacitors C₁ through C_{N} can each have a unique size relative to each other, such that each of the capacitors C₁ through C_{N} contribute a different amount of capacitance to the EMI filter stage 50. For instance, each of the capacitors C₁ through C_{N} can be incrementally larger by a power of two, such that the switching signals SW₁ through SW_{N} can be provided based on a binary code that corresponds to the amount of capacitance of the EMI filter stage 50. As a result, the controller 20 can selectively deactivate the switches S₁ through S_{N} to provide a range of capacitance values of the EMI filter stage 50 based on the magnitude of the load 12 relative to specification to substantially maximize a power factor associated with the power supply system 10.

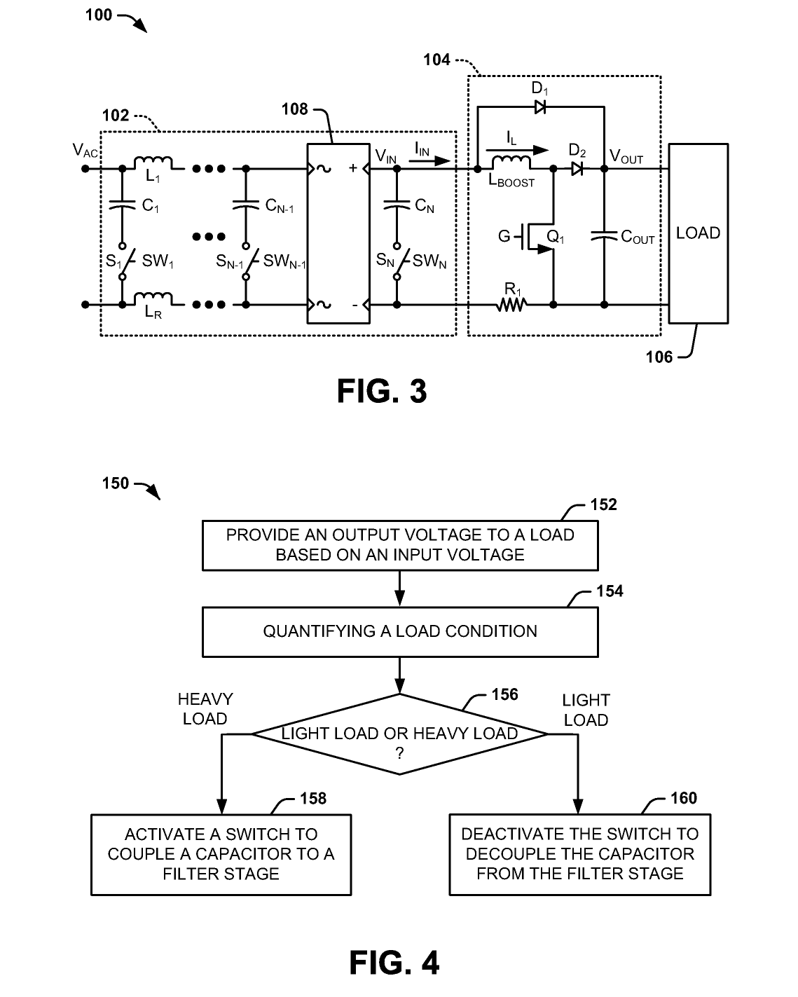

FIG. 3 illustrates another example of a power supply system 100. The power supply 100 includes an EMI filter stage 102, a power converter 104, and a load 106, such as can correspond to the EMI filter stage 14, the power converter 16, and the load 12, respectively, in the example of FIG. 1. Therefore, reference can be made to the example of FIG. 1 in the following description of the example of FIG. 3 for additional context.

The EMI filter stage 102 includes a plurality N of capacitors and a respective plurality N of switches, demonstrated in the example of FIG. 3 as C₁ through C_{N} and S₁ through S_{N}, respectively. Each of the capacitors C₁ through C_{N} can be connected in series with a respective one of the switches S₁ through S_{N}, with each of the series connections being separated by an inductor. While the example of FIG. 3 demonstrates only inductors L₁ and L_{R}, it is to be understood that the EMI filter stage 102 can include additional inductors separating series connections of the capacitors C₁ through C_{N} and the respective switches S₁ through S_{N}. Furthermore, while the example of FIG. 3 demonstrates that the inductor L_{R} is arranged as a differential inductor with respect to the inductor L₁, it is to be understood that the inductors L_{R} and L₁ could be arranged as common mode inductors with respect to each other. Therefore, the EMI filter stage 50 comprises a number of passive circuit components that can provide EMI filtering for the supply voltage V_{AC} based on the state of the respective switching signals SW₁ through SW_{N}, similar to as described in the example of FIG. 2.

Furthermore, in the example of FIG. 3, the EMI filter stage 102 also includes a rectifier 108 that is configured to rectify the supply voltage V_{AC} to generate the input voltage V_{IN} as a DC voltage. In the example of FIG. 3, the capacitor C_{N} and the switch S_{N} are demonstrated at an output of the rectifier 108. While the example of FIG. 3 demonstrates a single capacitor and respective single switch at the output of the rectifier 108, it is to be understood that any number of the inductors L₁ through L_{N-1}, capacitors C₁ though C_{N} and respective switches S₁ through S_{N} can be arranged at the output of the rectifier 108.

The input voltage V_{IN} is provided to the power converter 104. In the example of FIG. 3, the power converter 104 is configured as a power factor correcting boost converter. The power converter 104 includes a boost inductor L_{BOOST} that is coupled to a switch Q₁, demonstrated in the example of FIG. 3 as an N-type metal-oxide semiconductor FET (MOSFET), which is controlled by a gate signal G. Thus, a current I_{L} flows through the boost inductor L_{BOOST} to generate an output voltage V_{OUT} across an output capacitor C_{OUT}. A diode D₁ is arranged as bypassing the boost inductor L_{BOOST} to charge the output capacitor C_{OUT} during startup of the power converter 104. The switch Q₁ is activated to conduct the current I_{L} to reverse bias a diode D₂, allowing the output capacitor C_{OUT} to discharge into the load 106. The current I_{L} can thus flow through a resistor R₁ that acts as a power factor correcting feedback path to set the current across the resistor R₁ to follow the waveform of the supply voltage V_{AC}. The power converter 104 is thus configured as a power factor correcting boost converter that is configured to regulate both an input current I_{IN} provided from the output of the rectifier 108 and the output voltage V_{OUT}, which is provided to the load 106 at a magnitude that is greater than the input voltage V_{IN}.

As an example, the load 106 can be configured as a DC/DC power converter, such that the load 106 can regulate an additional output voltage that is generated based on the output voltage V_{OUT}. A power monitor, such as the power monitor 18 in the example of FIG. 1, can monitor the power of the power supply system 100, such as based on the output voltage V_{OUT} that is supplied to the load 106. The power monitor can thus provide an indication of the magnitude of the load 106 to a controller, such as the controller 20 in the example of FIG. 1. In response, the controller can selectively deactivate one or more of the switches S₁ through S_{N} in the EMI filter stage 102 to maximize the power factor of the power supply system 100 based on the magnitude of the load 106 (e.g., in a light-load condition) while maintaining compliance with filtering specification associated with the EMI filter stage 102.

In view of the foregoing structural and functional features described above, an example method will be better appreciated with reference to FIG. 4. While, for purposes of simplicity of explanation, the method of FIG. 4 is shown and described as executing serially, it is to be understood and appreciated that the method is not limited by the illustrated order, as parts of the method could occur in different orders and/or concurrently from that shown and described herein.

FIG. 4 illustrates an example of a method 150 for controlling a magnitude of an output current of a power supply system. At 152, an output voltage (e.g., the output voltage V_{OUT} of FIG. 1) is provided to a load (e.g., the load 12 of FIG. 1) based on an input voltage (e.g., the input voltage V_{IN} of FIG. 1) that is generated from an AC supply voltage (e.g., the supply voltage V_{AC} of FIG. 1). The output voltage can be supplied by a dynamic filter (e.g., the filter 14 of FIG. 1). At 154, a magnitude of a load is monitored. For example, the load can be monitored by a power monitor (e.g., the power monitor 18 of FIG. 1) based on a voltage, current or voltage and current supplied to the load. At 156, it is determined if the magnitude of the load corresponds to a full-load condition or a light-load condition based on a specification. At 158, a switch (e.g., the switches S₁ through S_{N} of FIG. 2) is activated to couple a capacitor (e.g., the capacitors C₁ through C_{N} of FIG. 2) to an EMI filter stage (e.g., the EMI filter stage 14 of FIG. 1) in the full-load condition, the EMI filter stage arranged to filter high frequency currents to the AC supply voltage. For example a switching system can be selective controlled (e.g., by the controller 20 of FIG. 1) to dynamically adjust the filtering on the input AC voltage based on the detected load condition. At 160, the switch can be deactivated to decouple the capacitor from the EMI filter stage in the light-load condition. The method 150 can repeat during operation to dynamically adjust the filter characteristics of the EMI filter stage depending on load conditions, as disclosed herein.

What have been described above are examples. It is, of course, not possible to describe every conceivable combination of components or methodologies, but one of ordinary skill in the art will recognize that many further combinations and permutations are possible. Accordingly, the invention is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A power supply system (10) comprising:
a power converter (16) to provide an output voltage to a load (12) based on an input voltage that is generated from an AC supply voltage;
a power monitor (18) to monitor a condition of the load (12); and
a filter stage (14) to dynamically filter high frequency currents generated by the power converter (16) from the AC supply voltage based on the condition of the load (12) to substantially maximize a power factor associated with the power supply system (10).

2. The system of claim 1, further comprising a controller (20) to receive a load signal indicative of the load (12) from the power monitor (18) and to control a capacitance of the filter stage (14) based on the load (12) and based on a specification.

3. The system of claim 2, wherein the filter stage (14) comprises an electromagnetic interference filter (EMI) filter stage (14), the EMI filter stage (14) comprising a switch (22) and a capacitor coupled in series, the controller (20) to decouple the EMI filter capacitor via the switch (22) in response to a light-load condition.

4. The system of claim 2, wherein the filter stage (14) comprises a plurality of switches (22) that are coupled in series to a respective plurality of capacitors, the controller (20) being to selectively decouple the plurality of capacitors via the respective plurality of switches (22) based on the load (12).

5. The system of claim 4, wherein each of the plurality of capacitors has a unique capacitance value.

6. The system of claim 4, wherein the input voltage is a DC voltage, and wherein the filter stage (14) comprises a rectifier (52) to convert the AC supply voltage into a DC input voltage.

7. The system of claim 6, wherein a first portion of the plurality of switches (22) and the plurality of capacitors is arranged at an input of the rectifier (52) and a second portion of the plurality of switches (22) and the plurality of capacitors is arranged at an output of the rectifier (52).

8. The system of claim 1, wherein the power converter (16) is configured as a power factor correcting power converter (104).

9. A power supply system (10) comprising:
a power converter (16) to provide an output voltage to a load (2) based on an input voltage that is generated from an AC supply voltage;
a power monitor (18) to monitor a load condition of the load (12);
an EMI filter stage (14) comprising a plurality of switches (22) coupled in series with a respective plurality of capacitors to filter the AC supply voltage; and
a controller (20) to selectively activate and deactivate the plurality of switches (22) to dynamically control a capacitance of the EMI filter stage (14) based on the load condition and based on a specification to substantially maximize a power factor associated with the power supply system (10).

10. The system of claim 9, wherein each of the plurality of capacitors has a different capacitance value.

11. The system of claim 9, wherein the input voltage is a DC voltage, and wherein the EMI filter stage (14) comprises a rectifier (52) to convert the AC supply voltage into the DC voltage.

12. The system of claim 9, wherein the power converter (16) is configured as a power factor correcting power converter (104).

13. A method (150) for dynamically providing EMI filtering in a power supply system (10), the method comprising:
providing an output voltage to a load (12) based on an input voltage that is generated from an AC supply voltage;
quantifying a load condition;
determining if the quantified load condition corresponds to a full-load condition or a light-load condition;
activating a switch (22) to couple a capacitor to an EMI filter stage (14) in the full-load condition, the EMI filter stage (14) arranged to filter high frequency currents to the AC supply voltage; and
deactivating the switch (22) to decouple the capacitor from the EMI filter stage (14) in the light-load condition.

14. The method of claim 13, wherein activating the switch (22) comprises activating a plurality of switches (22) to couple a respective plurality of capacitors to an EMI filter stage (14) in the full-load condition, and wherein deactivating the switch (22) comprises selectively deactivating the plurality of switches (22) to selectively decouple the respective plurality of capacitors from the EMI filter stage (14) in the light-load condition based on the magnitude of the load (12).

15. The method of claim 14, further comprising converting the input voltage to the output voltage by a power converter (16).
